(19) United States
(12) Patent Application Publication
(10) Pub. No.: US 2026/0222654 A1
(43) Pub. Date: Jul. 30, 2026

(54) TV SERIES SEARCH METHOD, ELECTRONIC DEVICE AND STORAGE MEDIUM

(71) Applicant: Douyin Vision Co., Ltd., Beijing (CN)

(72) Inventors: Yuxin SHAO, Beijing (CN); Guibo PAN, Beijing (CN); Gengxin WANG, Beijing (CN); Weisong CHEN, Beijing (CN); Hao SHEN, Beijing (CN)

(21) Appl. No.: 19/303,220

(22) Filed: Aug. 18, 2025

(30) Foreign Application Priority Data
Jan. 24, 2025 (CN) 202510122923.2

(51) Int. Cl. H04N 21/482; H04N 21/4722

(52) U.S. Cl. CPC H04N 21/4828; H04N 21/4722

(57) ABSTRACT

The present disclosure provides a TV series search method, an electronic device and a storage medium. The method includes: receiving picture content; determining, based on picture information of the picture content, a target series matching the picture content and a target episode in the target series, the picture information including at least one selected from a group of picture object information or picture scene information, and the target episode including an image frame matching the picture information of the picture content; and displaying, on a preset interface, key information of the target episode, the key information representing at least the picture content.

### CROSS-REFERENCE TO RELATED APPLICATION

This application claims the priority to and benefits of the Chinese Patent Application, No. 202510122923.2, which was filed on Jan. 24, 2025. The aforementioned patent application is hereby incorporated by reference in its entirety.

### TECHNICAL FIELD

Embodiments of the present disclosure relate to the field of computer technologies, and in particular, to a TV series search method, an electronic device and a storage medium.

### BACKGROUND

At present, in some applications, a user may be supported to search for TV series by means of text search. However, in the related art, a manner of searching for the TV series is relatively monotonous.

### SUMMARY

Embodiments of the present disclosure provide a TV series search method and apparatus, an electronic device, a storage medium and a program product to enrich manners of searching for TV series.

An embodiment of the present disclosure provides a method for searching TV series, comprising:
receiving picture content;
determining, based on picture information of the picture content, a target series matching the picture content and a target episode in the target series, the picture information comprising at least one selected from a group of picture object information or picture scene information, and the target episode comprising an image frame matching the picture information of the picture content; and
displaying, on a preset interface, key information of the target episode, the key information representing at least the picture content.

An embodiment of the present disclosure further provides a TV series search apparatus, comprising:
a picture receiving module, configured to receive picture content;
an episode determination module, configured to determine, based on picture information of the picture content, a target series matching the picture content and a target episode in the target series, the picture information comprising at least one selected from a group of picture object information or picture scene information, and the target episode comprising an image frame matching the picture information of the picture content; and
a key information display module, configured to display, on a preset interface, key information of the target episode, the key information representing at least the picture content.

An embodiment of the present disclosure further provides an electronic device, comprising:
one or more processors; and
a memory, configured to store one or more programs,
where the one or more programs, when executed by the one or more processors, cause the one or more processors to implement the method for searching TV series according to the embodiments of the present disclosure.

An embodiment of the present disclosure further provides a non-transitory computer-readable storage medium, on which a computer program is stored, where the computer program, when executed by at least a processor, implements the method for searching TV series according to the embodiments of the present disclosure.

An embodiment of the present disclosure further provides a computer program product, where the computer program product, when executed by a computer, causes the computer to implement the method for searching TV series according to the embodiments of the present disclosure.

### BRIEF DESCRIPTION OF DRAWINGS

The above and other features, advantages and aspects of the embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale.

FIG. 1 is a schematic flowchart of a TV series search method according to an embodiment of the present disclosure;

FIG. 2 is a schematic diagram of a TV series search process according to an embodiment of the present disclosure;

FIG. 3 is a schematic flowchart of another TV series search method according to an embodiment of the present disclosure;

FIG. 4 is a schematic diagram of another TV series search process according to an embodiment of the present disclosure;

FIG. 5 is a block diagram of a TV series search apparatus according to an embodiment of the present disclosure; and

FIG. 6 is a schematic structure diagram of an electronic device according to an embodiment of the present disclosure.

### DETAILED DESCRIPTION

The embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the various steps described in the method implementations of the present disclosure may be performed in different orders and/or in parallel. In addition, the method implementations may comprise additional steps and/or omit the execution of the steps shown. The scope of the present disclosure is not limited in this regard.

As used herein, the term “comprise/include” and its variations are open-ended inclusions, that is, “comprise/include but not limited to”. The term “based on” means “based at least in part on”. The term “an embodiment” means “at least one embodiment”; the term “another embodiment” means “at least one other embodiment”; the term “some embodiments” means “at least some embodiments”. Relevant definitions of other terms will be given in the following description.

It should be noted that the concepts such as “first” and “second” mentioned in the present disclosure are only used to distinguish different apparatuses, modules or units, and are not used to limit the order or interdependence of functions performed by these apparatuses, modules or units.

It should be noted that the modifications of “one” and “multiple” mentioned in the present disclosure are illustrative rather than restrictive, and those skilled in the art should understand that unless otherwise clearly indicated in the context, they should be understood as “one or more”.

The names of messages or information exchanged between multiple apparatuses in the implementations of the present disclosure are only used for illustrative purposes, and are not used to limit the scope of these messages or information.

It may be understood that the data involved in the technical solution (comprising but not limited to the data itself, acquisition or use of the data) should comply with requirements of corresponding laws, regulations and related provisions.

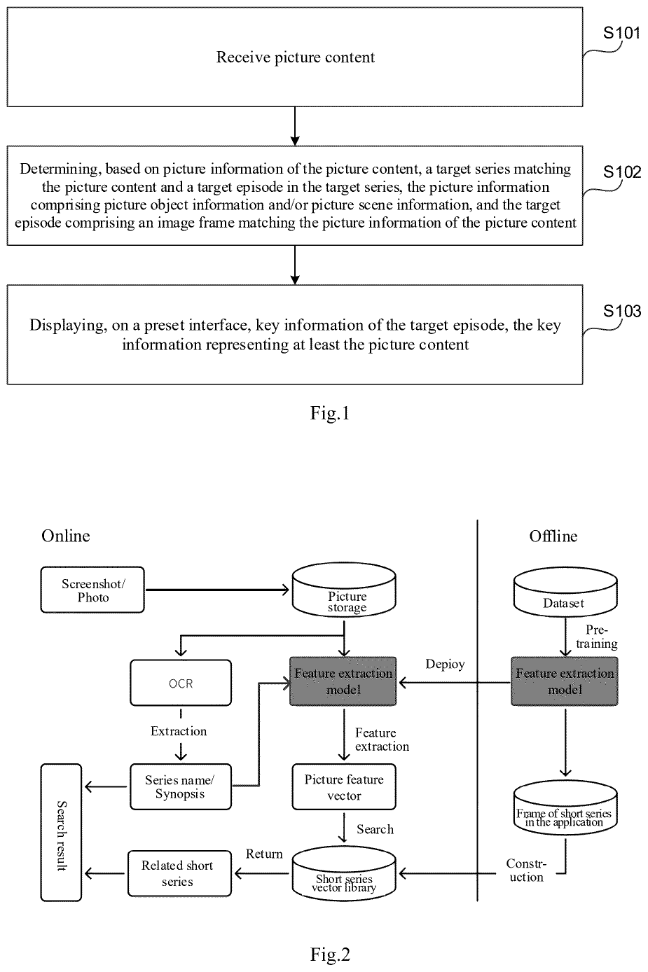

FIG. 1 is a schematic flowchart of a TV series search method according to an embodiment of the present disclosure. The method may be performed by a TV series search apparatus, where the apparatus may be implemented in a form of software and/or hardware, and may be configured in an electronic device, typically in a computer, a mobile phone or a tablet computer. The TV series search method provided by the embodiments of the present disclosure is applicable to a scenario of searching for TV series and an episode matching picture content in the TV series by means of picture search.

In a TV series scenario, such as a short series scenario, a user's series search process is mostly as follows: after viewing a short video associated with an TV series on a short video playback page, obtaining a name of the TV series, and inputting the name into a series search interface to search for the TV series, so as to view the TV series. However, the currently played short video is not necessarily marked with the name of the TV series, and moreover, in different applications, TV series (especially a short series) usually has multiple aliases, so it is impossible to simply find the corresponding TV series through text search. Furthermore, when the TV series is played after being found, the TV series generally starts to be played from a starting position of the TV series, which is not conducive for the user to view a plot associated with pictures in the short video.

In view of this, an embodiment of the present disclosure provides a TV series search method, which supports a user to search for a TV series through picture content, enriches manners of searching for the TV series, and reduces difficulty in searching for the TV series and difficulty in determining an episode associated with the picture content in the TV series.

As shown in FIG. 1, the TV series search method provided by the embodiment may comprise the following steps.

S101: receive picture content.

Specifically, the picture content may be received, for example, when a series search operation is received, the picture content corresponding to the series search operation may be received in response to the series search operation, so as to facilitate subsequent series search based on the picture content.

The picture content may be understood as a picture used for searching for a TV series. The series search operation may be understood as a trigger operation used to instruct to search for TV series based on the picture content. A manner of performing the series search operation is not limited, and exemplarily, the series search operation may be an operation of triggering a series search control or performing a series search gesture. Searching for TV series based on the picture content may be understood as searching for TV series matching the picture content and/or searching for an episode or an image frame matching the picture content in the TV series.

In this embodiment, a manner of receiving the picture content is not limited, for example, a currently displayed picture content, a generated picture content, and/or a user-selected picture content may be received as the picture content for searching for the TV series.

In some implementations, the user may be supported to acquire, based on media content displayed in a media content display interface, the picture content for searching for the TV series when viewing the media content displayed in the media content display interface, so as to further enrich the manner of acquiring the picture content and simplify operations that need to be performed to acquire the picture content.

Optionally, the step of receiving picture content comprises: receiving, in response to a first series search operation acting on the media content display interface, picture content currently displayed in the media content display interface.

The media content display interface may be understood as an interface for displaying the media content. The media content may be, for example, media content published in a current application, such as a video published in the current application. The first series search operation may be understood as a series search operation directed based on the media content display interface. A manner of performing the first series search operation is not limited, and exemplarily, the first series search operation may comprise an operation of triggering a series search control displayed in the media content display interface, or an operation of performing a series search gesture in the media content display interface.

Exemplarily, the media content may be displayed in the media content display interface, for example, a short video may be played in the media content display interface; and when a series search operation acting on the media content display interface is received, the picture content for searching for the TV series may be acquired based on the media content display interface, for example, when it is detected that the user triggers the series search control displayed in the media content display interface, a current interface image of the media content display interface, which is obtained by taking a screenshot of the media content display interface, may be acquired as the picture content for searching for the TV series.

In the implementations described above, a timing of performing the series search operation in the media content display interface is not limited.

In some implementations, the user may be supported to perform the series search operation before acquiring the picture content based on the media content display interface, for example, when the media content display interface is displayed or when the media content related to the TV series is displayed in the media content display interface, that is, an series search control for performing the series search operation is displayed in the media content display interface for the user to search for the TV series. Optionally, the step of receiving, in response to the first series search operation acting on the media content display interface, the picture content currently displayed in the media content display interface comprises: displaying a first series search control in the media content display interface; and acquiring, in response to the first series search operation acting on the first series search control, a current interface image of the media content display interface as the picture content.

The first acquisition control may be a control that is displayed in the media content display interface and that is used to trigger taking a screenshot and performing a TV series search. The current interface image may be understood as an image obtained based on at least part of interface content currently displayed in the media content display interface. Exemplarily, the current interface image may be a screenshot image obtained by taking a screenshot of the media content display interface, or may be a media content image currently displayed in the media content display interface, such as picture content or a video frame currently displayed in the media content display interface.

Exemplarily, when the media content is displayed in the media content display interface, the first series search control for the user to perform the series search operation may be further displayed in the media content display interface; and when it is detected that the user triggers the first series control, it may be determined that the first series search operation is received, and in response to the first series search operation, the current interface image of the media content display interface is acquired as the picture content for searching for the TV series, for example, a screenshot of the media content display interface is taken, and picture content obtained from the screenshot is used as the picture content for searching for the TV series; or picture content or a video frame currently displayed in the media content display interface is acquired as the picture content for searching for the TV series.

In some implementations, the user may be supported to perform the series search operation after acquiring the picture content based on the media content display interface, for example, a series search control for performing the first series search operation is displayed in response to a picture acquisition event acting on the media content display interface for the user to search for the TV series. Optionally, the step of receiving, in response to the first series search operation acting on the media content display interface, the picture content currently displayed in the media content display interface comprises:
acquiring, in response to a first picture acquisition interface acting on the media content display interface, a current interface image of the media content display interface, and displaying a second series search control; and determining, in response to an series search operation acting on the second series search control, the current interface image as the picture content.

In the implementations described above, when the media content display interface is initially displayed, the series search control for performing the series search operation may not be displayed, instead, in a case where the first picture acquisition interface acting on the media content display interface is received, the series search control for performing the series search operation is then displayed in the media content display interface, so as to improve the usability of the displayed series search control and reduce the occlusion of the media content displayed in the media content display interface caused by the display of the series search control.

The first picture acquisition interface may be understood as an operation for instructing to acquire an image content based on the media content display interface, for example, an operation for instructing to acquire the current interface image of the media content display interface. A manner of performing the first picture acquisition interface is not limited, and exemplarily, the first picture acquisition interface may comprise a screenshot operation for an image acquisition interface, and/or a save operation for an image content currently displayed in the media content display interface. The second series search control may be understood as a control that is displayed based on the first picture acquisition interface and that is used to trigger the execution of the first series search operation.

Exemplarily, when the first picture acquisition interface in the media content display interface is received, the current interface image of the media content display interface may be acquired, for example, a screenshot image of the media content display interface may be obtained by taking a screenshot of the media content display interface, or picture content currently displayed in the media content display interface may be saved. In response to the acquisition of the current interface image of the media content display interface, the second series search control is displayed, for example, acquisition complete prompt information for the current interface image is displayed in the media content display interface, and the second series search control is associated with the acquisition complete prompt information. In response to the first series search operation acting on the second series search control, the current interface image is used as the picture content for searching for the TV series.

In some implementations, the user may be supported to acquire, in the image acquisition interface, the picture content for searching for the TV series, so as to further enrich the manner of acquiring the picture content.

Optionally, the step of receiving the picture content comprises: receiving, in response to a second series search operation acting on the series search interface, picture content in an image acquisition interface.

The series search interface may be an interface used to search for TV series. The second series search operation may be understood as a series search operation acting on the series search interface, such as an operation of triggering an series search control displayed based on the series search interface. The image acquisition interface may be understood as an interface used to acquire the picture content, such as a shooting interface and/or an image set interface.

Exemplarily, the series search interface may be displayed based on a user's trigger operation, for example, the series search interface may be displayed; and when the second series search operation acting on the series search interface is received, the picture content in the image acquisition interface may be acquired, so as to facilitate subsequent series search based on the picture content.

In some implementations, the step of receiving, in response to the second series search operation acting on the series search interface, the picture content in the image acquisition interface comprises: displaying, in response to the second series search operation acting on the series search interface, the image acquisition interface; and acquiring, in response to a second picture acquisition interface acting on the image acquisition interface, picture content corresponding to the second picture acquisition interface in the image acquisition interface.

The second picture acquisition interface may be understood as an operation for instructing to acquire the picture content based on the image acquisition interface, for example, an operation for instructing to shoot the picture content in the image acquisition interface, or an operation for instructing to acquire a certain picture content in the image acquisition interface.

Specifically, when the second series search operation acting on the series search interface is received, for example, when a trigger operation for a picture control displayed in the series search interface is detected, the image acquisition interface may be displayed; and in response to the second picture acquisition operation acting on the image acquisition interface, the picture content corresponding to the second picture acquisition operation in the image acquisition interface is acquired as the picture content for searching for the TV series.

For example, when the second series search operation acting on the series search interface is received, the shooting interface may be displayed; and when a shooting operation (that is, the second picture acquisition interface) acting on the shooting interface is received, the picture content is shot, and the shot picture content is used as the picture content for this series search.

For another example, when the series search operation acting on the series search interface is received, the image set interface of the current user may be displayed, and image information of at least one picture content that is available for the current user to select is displayed in the image set interface; and when a picture selection operation (that is, the second picture acquisition interface) acting on the image set interface is received, for example, when it is detected that the current user triggers the image information of a certain picture content displayed in the image set interface, the picture content selected by the current user is acquired as the picture content for this series search.

S102: determining, based on picture information of the picture content, a target series matching the picture content and a target episode in the target series, the picture information comprising picture object information and/or picture scene information, and the target episode comprising an image frame matching the picture information of the picture content.

The picture information of the picture content may be understood as information used to describe picture content of the picture content. The picture information may comprise picture object information and/or picture scene information. The picture object information may be understood as information about an object appearing in a picture of the picture content, such as information about a person and/or an animal appearing in the picture of the picture content. The picture scene information may be understood as information about a scene presented in the picture of the picture content, such as information about a picture background, a building, or another item in the picture of the picture content. The target series may be understood as TV series matching the picture content, for example, TV series comprising an image frame matching the picture content. Exemplarily, the target series may be TV series, such as a series or a unit play, that has multiple episodes. The target episode may be understood as an episode matching the picture content in the target series, and it may be an episode comprising an image frame matching the picture content in the target series. The image frame matching the picture information of the picture content may be an image frame whose similarity to the picture information of the picture content is greater than or equal to a preset similarity threshold, and the image frame may be, for example, a series frame in the target series.

Specifically, after the picture content for the series search is received, the target series matching the picture content and the target episode comprising the image frame matching the information of the picture content in the target series may be determined based on the picture information of the picture content, so as to subsequently display the series search result to the user based on the target episode.

In this embodiment, a manner of determining the target series and the target episode in the target series based on the picture information of the picture content is not limited.

In some implementations, a picture feature vector of the picture content may be extracted based on the picture information of the picture content, an image frame matching the picture content may be determined according to a similarity between the picture feature vector of the picture content and image frame feature vectors of image frames in each TV series, TV series comprising the image frame matching the picture content may be determined as the target series matching the picture content, and an episode comprising the image frame matching the picture content in the target series may be determined as the target episode in the target series.

FIG. 2 is a schematic diagram of a series search process according to an embodiment of the present disclosure. In an optional implementation, as shown in FIG. 2, taking a short series search scenario as an example, a process of searching for a short series based on picture content may be described as follows:
A feature extraction model for extracting a picture feature is obtained through pre-training. After the feature extraction model is obtained through training, an image frame feature vector of each image frame in each episode of each short series in a current application may be extracted by using the feature extraction model, to construct a short series vector library of the current application.

In this way, after the picture content for the series search is received, the picture content may be input into the feature extraction model. In addition, character information in the picture content is extracted through optical character recognition (Optical Character Recognition). In response that it is identified and determined that there is character information in a picture in the picture content, a series name and/or a synopsis of a short series (that is, the target series) that corresponds to the picture content and needs to be acquired may be obtained through analysis based on the character information, and the series name and/or the synopsis are further input into the feature extraction model. The feature extraction model may extract the picture feature vector of the picture content based on the picture information of the picture content or based on the picture information of the picture content and the input information such as the series name and/or the synopsis. In this way, after the picture feature vector of the picture content is obtained, the similarity between the picture content and each image frame of each short series may be calculated based on the picture feature vector and the image frame feature vector of the image frame of each short series stored in the short series vector library, an image frame whose similarity to the picture content is greater than the preset similarity threshold is acquired, a short series to which the image frame belongs is determined as the short series (that is, the target series) matching the picture content, and an episode to which the image frame belongs in the short series may be further determined as the target episode.

Exemplarily, when performing feature extraction on the picture content, the feature extraction model may first preprocess the picture content, for example, process stain and/or deformation of the picture content; identify a key picture area of the picture content through center point identification and/or edge detection; intercept the key picture area; perform scaling processing on the intercepted key picture area, adjust it to a gray image, and perform picture feature extraction on the gray image to obtain the picture feature vector of the to-be-searched picture, so as to further improve the accuracy of the extracted picture feature vector, thereby improving the accuracy of the series search result.

In some implementations, the determining, based on picture information of the picture content, a target series matching the picture content and a target episode in the target series comprises: determining, based on picture object information of the picture content, the target series matching the picture content; and determining, based on the picture object information and picture scene information of the picture content, the target episode in the target series.

Exemplarily, the target series matching the picture content may be determined based on the picture object information of the picture content, and then the target episode in the target series is determined based on the picture object information and the picture scene information of the picture content.

For example, the picture object information of the picture content may comprise appearance information and/or posture information of an object appearing in the picture content, the appearance information may comprise, for example, appearance information and/or clothing information, and the posture information may be used to represent a posture of the object appearing in the picture of the picture content. In some examples, the target series matching the picture content may be determined based on the appearance information of the object appearing in the picture content, and the target episode in the target series that matches the picture information of the picture content may be determined based on the posture information of the object appearing in the picture content and the picture scene information of the picture content.

S103: displaying, on a preset interface, key information of the target episode, the key information representing at least the picture content.

The preset interface may be understood as an interface for displaying the key information of the target episode that is searched for and determined based on the picture content. The preset interface is not limited, and for example, the preset interface may be a series search result interface and/or an interface displayed when the image content is received. The key information of the target episode may represent at least the picture content, for example, the key information of the target episode may present the picture content and/or an image frame matching the picture content in the target episode. A manner of presenting the picture content and/or the image frame is not limited, and exemplarily, the picture content and/or the image frame may be displayed in the preset interface in the form of a series cover of the target series and/or an episode cover of the target episode.

Specifically, after the target episode in the target series is determined, the key information of the target episode may be displayed on the preset interface, for example, the picture content and/or an image frame matching the picture content in the target episode may be displayed on the preset interface in the form of the series cover of the target series and/or the episode cover of the target episode, so that the user may quickly determine, based on the key information of the target episode, the target episode matching the picture content searched for by the user in the target series.

According to the TV series search method provided by this embodiment, picture content is received; a target series matching the picture content and a target episode in the target series are determined based on picture information of the picture content, the picture information comprising picture object information and/or picture scene information, and the target episode comprising an image frame matching the picture information of the picture content; and key information of the target episode is displayed on a preset interface, the key information representing at least the picture content. According to the technical solution described above, this embodiment supports a series search based on the picture object information and/or the picture scene information of the picture content, and determines the target series matching the picture content and the target episode in the target series matching the picture content, so that manners of searching for the TV series may be enriched, and difficulty in searching for the TV series and difficulty in viewing an episode matching an image content in the TV series are reduced.

In some embodiments, the method further comprises: obtaining, based on the picture content and the target series matching the picture content, series recommendation information in a plurality of dimensions, the plurality of dimensions comprising at least one of an series plot dimension, an series object dimension, and an series background dimension; determining, based on the series recommendation information in the plurality of dimensions, recommended series in the plurality of dimensions, respectively; and displaying, on the preset interface, series information of the recommended series.

The series recommendation information may be understood as information on which series recommendation is based, in other words, series recommendation may be performed based on the series recommendation information. The series recommendation information may comprise a plurality of dimensions, and the plurality of dimensions may comprise at least a series plot dimension, an series object dimension, and an series background dimension. The series plot may be understood as a plot of a series, and the series object may be understood as an object appearing in an TV series, such as a character couple (CP) appearing in TV series and/or an actor in TV series. The series background may be understood as a background in which a plot in TV series occurs, which may comprise a location background and/or an age background. The recommended series may be understood as series recommended based on the series recommendation information. The series information of the recommended series may comprise, for example, names, covers, historical interaction information, and/or introduction information of the recommended series. The historical interaction information of the recommended series may be used to describe historical interaction situations of the recommended series, such as the number of historical plays and/or the number of historical comments of the recommended series.

This embodiment may support series recommendation based on the target series matching the image content, so as to further enrich TV series shown to the user based on the series search operation of the user, to satisfy different series viewing requirements of the user.

Specifically, after the target series matching the picture content is determined, the series recommendation information in the plurality of dimensions may be determined based on the target series or further in combination with the picture content, for example, series recommendation information in the series plot dimension (such as series plot information available for series recommendation), series recommendation information in the series object dimension (such as series object information available for series recommendation), and/or series recommendation information in the series background dimension (such as series background information available for series recommendation) that are used as a basis for series recommendation are determined; the recommended series in each of the dimensions are determined based on the series recommendation information in each of the dimensions, respectively; and the series information of the determined recommended series may be displayed on the preset interface, to implement series recommendation.

In this embodiment, a manner of displaying the series information of the recommended series on the preset interface is not limited. Optionally, the step of displaying, on the preset interface, the series information of the recommended series comprises: displaying, on the preset interface, the series information of the recommended series in different dimensions, where the series information of the recommended series in different dimensions is displayed in different areas of the preset interface; or displaying, on the preset interface, the series information and dimension information of the recommended series. For example, the series information of the recommended series in different dimensions may be displayed in different areas of the preset interface according to the recommendation dimensions; or the series information of the recommended series may be displayed without distinguishing the dimensions, for example, a display sequence of the series information of different recommended series on the preset interface is determined based on other parameters such as recommendation degrees of the recommended series on the preset interface. In this case, exemplarily, when the series information of the recommended series is displayed on the preset interface, the dimension information of the recommended series may be further displayed to facilitate viewing by the user.

In addition, in some examples, in the case where there is character information in the picture content, a short series outside the current application may also be searched for based on the series name and/or the synopsis determined according to the character information, as a short series matching the picture content. For example, in the case where no TV series comprising the image frame matching the picture content is searched for in the current application, a short series outside the current application may be searched for based on the series name and/or the synopsis determined according to the character information, as a target short series matching the picture content. In this case, the key information of the target episode in the target series may not be displayed on the preset interface, for example, only the series information of the recommended series determined based on the target series may be displayed; or the series information of the target series may be displayed, without displaying the key information of the target series, etc.

In some embodiments, after the step of displaying, on the preset interface, the key information of the target episode, the method further comprises: playing the target series in response to a series playback operation acting on the key information; and adjusting a playback progress of the target series based on the image frame in response to a progress adjustment operation for the target series.

The series playback operation may be a trigger operation for instructing to play the target series that is searched for and determined based on the picture content. A manner of performing the series playback operation is not limited, and exemplarily, the series playback operation may be an operation of triggering key information of a certain target episode displayed on the preset interface. The progress adjustment operation may be understood as a trigger operation for instructing to adjust the playback progress of the currently played target series based on the target episode in the target series. A manner of performing the progress adjustment operation is not limited, and exemplarily, the progress adjustment operation may comprise an operation of triggering a progress adjustment control displayed in the playing interface of the target series, and/or an operation of triggering image frame information of a certain image frame that matches the picture content and that is displayed in the playing interface of the target series.

Specifically, when the series playback operation for the target series is received, the target series may be played in the playing interface; and when the progress adjustment operation for the target series is received, the playback progress of the target series may be adjusted based on the image frame matching the picture content in the target series.

When the target series is played, exemplarily, the target series may be played from the starting position of the target series; or a certain target episode in the target series may be played, for example, the target episode corresponding to the series playback operation may be played, which may be specifically and flexibly set as required. When a certain target episode is played, exemplarily, the target episode may be played from the starting position of the target episode; and optionally, an image frame matching the picture content in the target episode may be used as a playing starting point to play the target episode, so that the user may continue to view the series content after the picture content searched for by the user.

When the playback progress of the target series is adjusted based on the image frame matching the picture content in the target series, exemplarily, when the progress adjustment operation for the currently played target series is received, the target image frame corresponding to the progress adjustment operation in the target series may be determined in response to the progress adjustment operation, and the current playback progress of the target series is adjusted to the playback progress corresponding to the target image frame, so as to play the target image frame. In this case, optionally, in this case, optionally, the step of adjusting the playback progress of the target series based on the image frame in response to the progress adjustment operation for the target series comprises: determining, in response to the progress adjustment operation for the target series, a target image frame corresponding to the progress adjustment operation in the target series, and adjusting the current playback progress of the target series to a target playback progress corresponding to the target image frame.

In this embodiment, the target image frame may be understood as an image frame, corresponding to the currently received progress adjustment operation, in the image frames of the target series that match the picture content searched for by the user, that is, an image frame instructed to switch to by the currently received progress adjustment operation. A manner of determining the target image frame is not limited. Exemplarily, when manners of performing the progress adjustment operation are different, the target image frame may be determined in different determining manners.

In some implementations, the progress adjustment operation may act on a progress adjustment control of the target series played in the playing interface, and the target image frame may be determined based on the current playback progress of the target series. For example, when the progress adjustment operation acting on the progress adjustment displayed in the playing interface is received, an image frame that is closest to the current playback progress of the target series, that is located before the current playback progress, and that matches the picture content searched for by the user may be acquired as the target image frame, or an image frame that is closest to the current playback progress of the target series, that is located after the current playback progress, and that matches the picture content searched for by the user may be acquired as the target image frame, and the current playback progress of the target series is adjusted to the playback progress corresponding to the target image frame. In this case, optionally, the method further comprises: displaying, in response to the playing of the target series, a progress adjustment control corresponding to the image frame, where the progress adjustment control is configured to trigger the execution of the progress adjustment operation. The progress adjustment control may be a control used to switch the image frame matching the picture content, for example, the progress adjustment control may be used to switch the image frame according to the sequence of the image frames matching the picture content in the target series.

In some implementations, the progress adjustment operation may act on image frame information, displayed in the playing interface, of a certain image frame matching the picture content, and the target image frame may be an image frame corresponding to the image frame information that the progress adjustment operation acts on. For example, when a certain target episode of the target series is played, the image frame information of the image frame matching the picture content in the target episode may be displayed in the playing interface; and when the progress adjustment operation acting on certain video frame information displayed in the playing interface is received, the image frame corresponding to the image frame information may be used as the target image frame, and the current playback progress of the target series is adjusted to the playback progress corresponding to the target image frame. In this case, optionally, the method further comprises: displaying, in response to the playing of the target episode in the target series, the image frame information of the image frame in the currently played target episode, where the image frame information is configured to trigger the execution of the progress adjustment operation. The image frame information of the image frame may comprise, for example, time point information, playback progress information, and/or picture information (such as a thumbnail) of the image frame in the target episode, which is not limited in this embodiment. A manner of displaying the image frame information in the playing interface is not limited, and exemplarily, the image frame information of the image frame matching the picture content in the target episode may be displayed in association in a playback progress bar of the currently played target episode, for example, an image frame progress identification corresponding to the image frame is displayed at a progress point position corresponding to the image frame on the playback progress bar of the target episode, and the playback progress corresponding to the image frame matching the picture content is instructed by the image frame progress identification.

In addition, in the case where the series information of the recommended series is displayed on the preset interface, when a playback operation for a certain recommended series is received, for example, when it is detected that the user triggers the series information of a certain recommended series displayed on the preset interface, the recommended series may be played in the playing interface, for example, the start point of the recommended series is used as a playing start point, and the recommended series is played in the playing interface.

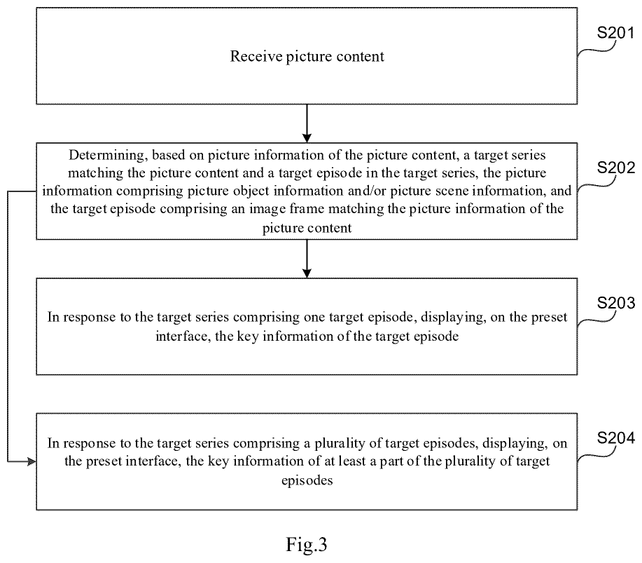

FIG. 3 is a schematic flowchart of another TV series search method according to an embodiment of the present disclosure. The solution in this embodiment may be combined with one or more optional solutions in the above embodiment. Optionally, the step of displaying, on the preset interface, the key information of the target episode comprises: in response to the target series comprising one target episode, displaying, on the preset interface, the key information of the target episode; and/or in response to the target series comprising a plurality of target episodes, displaying, on the preset interface, key information of at least some of the plurality of target episodes.

Correspondingly, as shown in FIG. 3, a video content playing method provided by this embodiment may comprise the following steps.

S201: receive picture content.

S202: determining, based on picture information of the picture content, a target series matching the picture content and a target episode in the target series, and performing S203 or S204, the picture information comprising picture object information and/or picture scene information, and the target episode comprising an image frame matching the picture information of the picture content.

S203: in response to the target series comprising one target episode, displaying, on the preset interface, the key information of the target episode.

In this embodiment, in the case where the target series comprises only one target episode, the key information of the target episode comprised in the target series may be displayed on the preset interface.

S204: in response to the target series comprising a plurality of target episodes, displaying, on the preset interface, the key information of at least a part of the plurality of target episodes.

Specifically, in the case where the target series comprises a plurality of target episodes, the key information of at least some of the target episode comprised in the target series may be displayed on the preset interface, for example, the key information of one or more target episode comprised in the target series may be displayed on the preset interface.

In this embodiment, a manner of determining the target episode whose key information is displayed on the preset interface is not limited.

In some implementations, the step of displaying, on the preset interface, the key information of at least some of the target episode comprises: determining a first target episode from the plurality of target episodes based on authorized historical behavior information of a current account, and displaying, on the preset interface, the key information of the first target episode.

The current account may be understood as an account which is currently logged in on a current application that performs the TV series search method provided by the embodiments of the present disclosure. The historical behavior information of the current account may be understood as historical behavior information of the current account in the current application, which may comprise but is not limited to historical play behavior information of the current account, such as historical media content play behavior information or historical series play behavior information. It should be noted that the historical behavior information of the current account is acquired on the premise that the user has given full authorization, and in response to the user does not give authorization, the historical behavior information of the current account will not be acquired. The first target classification may be understood as a target episode, to be shown key information of which, that is determined based on the historical behavior information of the current account.

In the above implementations, the key information of the target episode that is consistent with the historical behavior information of the current account may be displayed on the preset interface according to the historical behavior information of the current account, thereby improving the practicality of the displayed key information of the target episode.

Exemplarily, after the target episode in the target series is determined, the historical behavior information of the current account may be acquired on the premise that the user gives authorization. The first target episode consistent with the historical behavior information of the current account is determined in the target series, for example, in the case where the current account has not played the target series, the first target episode in the target series may be used as the first target episode; in the case where the current account has played the target series, based on the historical playback progress of the current account for the target series, the first target episode after the historical playback progress may be used as the first target episode, etc. The key information of the first target episode is displayed on the preset interface.

In some implementations, the step of displaying, on the preset interface, the key information of at least some of the target episode comprises: determining a second target episode from the plurality of target episodes based on historical interaction information and/or plot information of the plurality of target episodes, and displaying, on the preset interface, the key information of the second target episode.

The second target episode may be understood as a target episode determined based on historical interaction information and/or plot information of each of the target episode in the target series.

In the above implementations, the target episode whose key information is to be displayed may also be determined based on each of the target episode in the target series.

Exemplarily, the second target episode in the target series may be determined by acquiring the historical interaction information and/or the plot information of each of the target episode in the target series, for example, a preset plot corresponding to each of the target episode in the target series may be acquired based on the plot information of each of the target episode in the target episode, and the first target episode presenting the preset plot may be acquired as the second target episode; and/or a target episode with the largest number of historical plays and/or with the best historical evaluation in the target series may be acquired as the second target episode based on the historical interaction situation of each of the target episode. The key information of the second target episode is displayed on the preset interface.

In some implementations, the step of displaying, on the preset interface, the key information of at least some of the target episode comprises: displaying, on the preset interface, the key information of each of the plurality of target episodes and the plot prompt information of each of the plurality of target episodes, the plot prompt information for prompting a plot corresponding to the picture content in the target episode.

In the above implementations, when there are a plurality of target episodes in the target series, the key information of each of the target episode in the target series may also be displayed separately on the preset interface, and the plot prompt information of each of the target episode may be further displayed. The plot corresponding to each target classification is prompted by the plot prompt information, so that the user may quickly select a target episode to be watched based on the plot of each target episode, thereby reducing the difficulty in selecting the target episode.

A manner of displaying the key information and the plot prompt information of each of the target episode on the preset interface is not limited, and exemplarily, the key information and the plot prompt information of each of the target episode in the target series may be displayed simultaneously on the preset interface; or the key information and the plot prompt information of different target episode in the target series may be switched and displayed on the preset interface, which may be flexibly set according to actual needs.

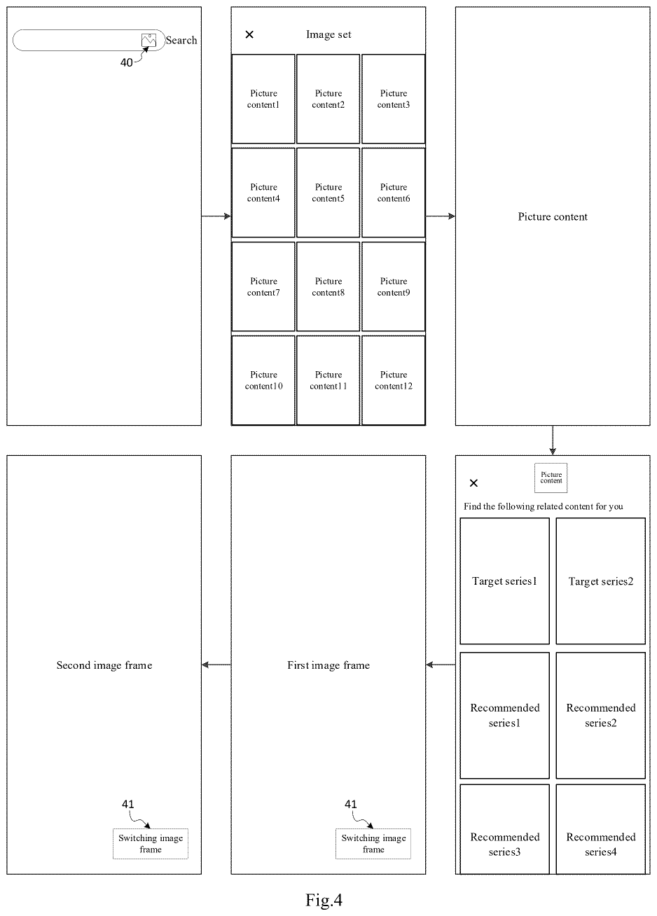

FIG. 4 is a schematic diagram of another series search process according to an embodiment of the present disclosure. As shown in FIG. 4, in an optional embodiment, the TV series search method provided by this embodiment may be described as follows:
A series search interface is displayed, as shown in the first picture in the first row in FIG. 4.

When it is detected that a current user triggers an image control 40 displayed in a video content search interface, it may be determined that an series search operation is received, and in response to the series search operation, an image set interface (that is, the image acquisition interface) of the current user is displayed, and at least one piece of picture content is displayed in the image set interface, for example, image information (such as a thumbnail) of at least one piece of picture content is displayed in the image set interface, as shown in the second picture in the first row in FIG. 4.

When it is detected that the current user triggers a certain piece of picture content displayed in the image set interface, it may be determined that the second picture acquisition operation is received, and in response to the second picture acquisition operation, the piece of picture content triggered by the current user is acquired, and the series search is performed based on the piece of picture content, for example, a target series matching the piece of picture content and a target episode in the target series are determined based on picture information of the piece of picture content, and a search prompt interface may be displayed during the series search process, and it is prompted by the search prompt interface that the series search is being performed based on the picture content, and the piece of picture content may be displayed in the search prompt interface, as shown in the third picture in the first row in FIG. 4.

After the target series is searched for and determined, the key information of the target episode in the target series may be displayed on the preset interface, for example, at least one image frame matching the picture content in the target series may be displayed; and the series information of at least one recommended series recommended based on the picture content and/or the target series may be further displayed on the preset interface, as shown in the third picture in the second row in FIG. 4. The number of target series and/or the number of recommended series may be one or more.

When it is detected that the current user triggers the key information of a certain target episode displayed on a certain preset interface, it may be determined that the series playback operation for the target series is received, and in response to the series playback operation, the playing interface is displayed, and the target episode in the target series is played in the playing interface, for example, a first image frame matching the picture content in the target episode is used as a playing start point to play the target episode, as shown in the second picture in the second row in FIG. 4.

When it is detected that the current user triggers the image frame switching control 41 displayed in the playing interface, it may be determined that the progress adjustment operation is received, and in response to the progress adjustment operation, the current playback progress of the target series is switched to the playback progress corresponding to a second image frame matching the picture content, and the second image frame may be, for example, a previous image frame or a next image frame of the current playback progress that matches the image content.

According to the TV series search method provided by this embodiment, the key information of the target episode may be displayed in different manners based on different target episode comprised in the target series, so that manners of displaying the key information of the target episode may be further enriched, and viewing of the target episode recommended to be played by the user is facilitated.

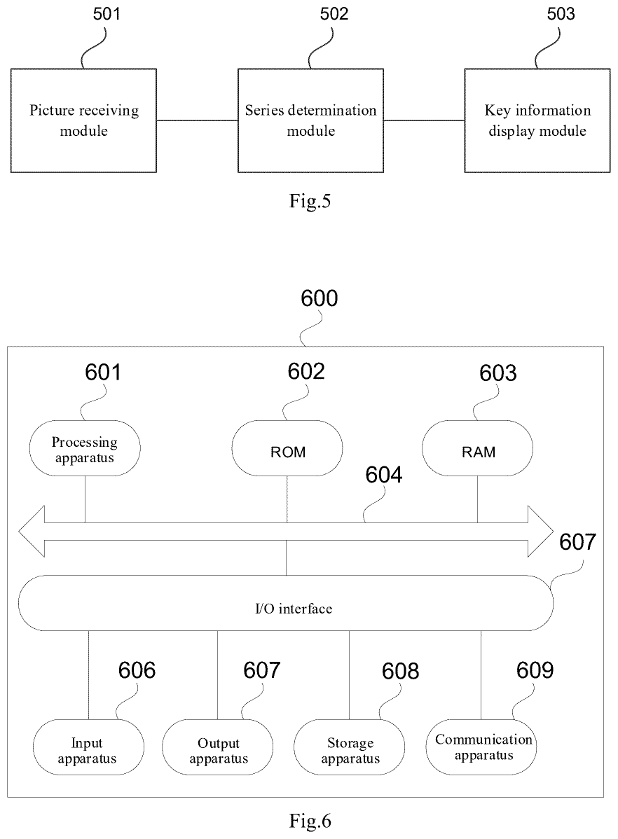

FIG. 5 is a block diagram of a TV series search apparatus according to an embodiment of the present disclosure. The apparatus may be implemented in a form of software and/or hardware, and may be configured in an electronic device, typically in a computer, a mobile phone or a tablet computer. The apparatus may perform a series search by means of picture search by performing an TV series search method. As shown in FIG. 5, the series search apparatus provided by this embodiment may comprise a picture receiving module 501, a series determination module 502 and a key information display module 503.

The picture receiving module 501 is configured to receive picture content.

The series determination module 502 is configured to determine, based on picture information of the picture content, a target series matching the picture content and a target episode in the target series, the picture information comprising picture object information and/or picture scene information, and the target episode comprising an image frame matching the picture information of the picture content.

The key information display module 503 is configured to display, on a preset interface, key information of the target episode, the key information representing at least the picture content.

According to the series search apparatus provided by this embodiment, picture content is received by a picture receiving module; a target series matching the picture content and a target episode in the target series are determined by a series determination module based on picture information of the picture content, the picture information comprising picture object information and/or picture scene information, and the target episode comprising an image frame matching the picture information of the picture content; and key information of the target episode is displayed by a key information display module on a preset interface, the key information representing at least the picture content. According to the technical solution described above, this embodiment supports an series search based on the picture object information and/or the picture scene information of the picture content, and determines the target series matching the picture content and the target episode in the target series matching the picture content, so that manners of searching for the TV series may be enriched, and difficulty in searching for the TV series and difficulty in viewing an episode matching an image content in the TV series are reduced.

Optionally, the key information display module 503 may comprise a first key information display unit and/or a second key information display unit. The first key information display unit is configured to, in response to the target series comprising one target episode, display, on a preset interface, key information of the target episode. The second key information display unit is configured to, in response to the target series comprising a plurality of target episodes, display, on the preset interface, key information of at least some of the plurality of target episodes.

Optionally, the second key information display unit may be further configured to: determine a first target episode from the plurality of target episodes based on authorized historical behavior information of a current account, and display, on the preset interface, key information of the first target episode; or determine a second target episode from the plurality of target episodes based on historical interaction information and/or plot information of the plurality of target episodes, and display, on the preset interface, key information of the second target episode; or display, on the preset interface, the key information of each of the plurality of target episodes and the plot prompt information of each of the plurality of target episodes, the plot prompt information for prompting a plot corresponding to the picture content in the target episode.

Optionally, the series determination module 502 may be further configured to: determine, based on picture object information of the picture content, the target series matching the picture content; and determine, based on the picture object information and picture scene information of the picture content, the target episode in the target series.

Further, the series search apparatus may further comprise a recommendation information acquisition module, a recommended series determination module and a series information display module. The recommendation information acquisition module is configured to obtain, based on the picture content and the target series matching the picture content, series recommendation information in a plurality of dimensions, the plurality of dimensions comprising at least one of a series plot dimension, an series object dimension, and an series background dimension. The recommended series determination module is configured to determine, based on the series recommendation information in the plurality of dimensions, recommended series in the plurality of dimensions, respectively. The series information display module is configured to display, on a preset interface, series information of the recommended series.

Optionally, the series information display module may be further configured to: display, on the preset interface, the series information of the recommended series in different dimensions, where the series information of the recommended series in different dimensions is displayed in different areas of the preset interface; or display, on the preset interface, the series information and dimension information of the recommended series.

Further, the series search apparatus may further comprise a series playing module and a progress adjustment module. The series playing module is configured to, after the step of displaying, on the preset interface, the key information of the target episode, play the target series in response to a series playback operation acting on the key information. The progress adjustment module is configured to adjust a playback progress of the target series based on the image frame in response to a progress adjustment operation for the target series.

Optionally, the progress adjustment module may be further configured to: determine, in response to the progress adjustment operation for the target series, a target image frame corresponding to the progress adjustment operation in the target series, and adjust the current playback progress of the target series to a target playback progress corresponding to the target image frame.

Further, the series search apparatus may further comprise a control display module and/or an image frame information display module. The control display module is configured to display, in response to the playing of the target series, a progress adjustment control corresponding to the image frame, where the progress adjustment control is configured to trigger the execution of the progress adjustment operation. The image frame information display module is configured to display, in response to the playing of the target episode in the target series, image frame information of the image frame in the currently played target episode, where the image frame information is configured to trigger the execution of the progress adjustment operation.

Optionally, the picture receiving module 501 may be further configured to: receive, in response to a first series search operation acting on a media content display interface, picture content currently displayed in the media content display interface; and/or receive, in response to a second series search operation acting on a series search interface, picture content in an image acquisition interface.

The series search apparatus provided by the embodiments of the present disclosure may perform the TV series search method provided by any embodiment of the present disclosure, and has corresponding functional modules and beneficial effects for performing the TV series search method. For technical details not described in detail in this embodiment, reference may be made to the TV series search method provided by any embodiment of the present disclosure.

Reference is made to FIG. 6 below, which illustrates a schematic structure diagram of an electronic device (e.g., a terminal device) 600 suitable for implementing the embodiments of the present disclosure. The terminal device in the embodiments of the present disclosure may comprise, but is not limited to, a mobile terminal such as a mobile phone, a notebook computer, a digital broadcast receiver, a personal digital assistant (PDA), a tablet computer, a portable media player (PMP), a vehicle-mounted terminal (e.g., a vehicle navigation terminal), and a fixed terminal such as a digital TV, and a desktop computer. The electronic device shown in FIG. 6 is merely an example, which should not impose any limitation on the function and scope of use of the embodiments of the present disclosure.

As shown in FIG. 6, the electronic device 600 may comprise a processing apparatus (e.g., a central processing unit, a graphics processing unit, etc.) 601, which may perform various appropriate actions and processing according to a program stored in a read-only memory (ROM) 602 or a program loaded from a storage apparatus 608 into a random-access memory (RAM) 603. In the RAM 603, various programs and data required for operations of the electronic device 600 are also stored. The processing apparatus 601, the ROM 602 and the RAM 603 are connected to each other through a bus 604. An input/output (I/O) interface 605 is also connected to the bus 604.

Usually, the following apparatuses may be connected to the I/O interface 605: an input apparatus 606 comprising, for example, a touch screen, a touchpad, a keyboard, a mouse, a camera, a microphone, an accelerometer, a gyroscope, etc. ; an output apparatus 607 comprising, for example, a liquid crystal display (LCD), a speaker, a vibrator, etc. ; a storage apparatus 608 comprising, for example, a magnetic tape, a hard disk, etc. ; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or provide all the apparatuses shown. More or fewer apparatuses may be implemented or provided alternatively.

In particular, according to the embodiments of the present disclosure, the process described above with reference to the flowchart may be implemented as a computer software program. For example, the embodiments of the present disclosure comprise a computer program product comprising a computer program carried on a non-transitory computer-readable medium, the computer program comprising program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above functions defined in the method of the embodiments of the present disclosure are performed.

It should be noted that the above computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus or device, or any combination thereof. More specific examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus or device. In the present disclosure, the computer-readable signal medium may comprise a data signal propagated on a baseband or as a part of a carrier, and computer-readable program code is carried in the data signal. The data signal propagated in this way may be in multiple forms, and comprises, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus or device. The program code contained in the computer-readable medium may be transmitted in any suitable medium, comprising, but not limited to, a wire, an optical cable, a radio frequency (RF), or any suitable combination thereof.

In some implementations, a client and a server may communicate using any currently known or future developed network protocol, such as the hypertext transfer protocol (HTTP), and may be interconnected with any form or medium of digital data communication (for example, a communication network). Examples of the communication network comprise a local area network (“LAN”), a wide area network (“WAN”), an internet (for example, the Internet), a peer-to-peer network (for example, an Ad-Hoc network), and any network currently known or to be developed in the future.

The above computer-readable medium may be comprised in the above electronic device, or may exist alone without being assembled into the electronic device.

The above computer-readable medium carries one or more programs, which, when executed by the electronic device, cause the electronic device to: receive picture content; determine, based on picture information of the picture content, a target series matching the picture content and a target episode in the target series, the picture information comprising picture object information and/or picture scene information, and the target episode comprising an image frame matching the picture information of the picture content; and display, on a preset interface, key information of the target episode, the key information representing at least the picture content.

The computer program code for performing the operations of the present disclosure may be written in one or more programming languages or a combination thereof, where the programming languages comprise, but are not limited to, an object-oriented programming language such as Java, Smalltalk, C++, and further comprise conventional procedural programming languages such as “C” language or similar programming languages. The program code may be executed entirely on a user computer, partly executed on a user computer, executed as an independent software package, partly executed on a user computer and partly executed on a remote computer, or entirely executed on a remote computer or a server. In the case of involving a remote computer, the remote computer may be connected to the user computer through any kind of network, comprising a local area network (LAN) or a wide area network (WAN), or may be connected to an external computer (for example, connected by using Internet provided by an Internet service provider).

The flowcharts and block diagrams in the drawings illustrate the possibly implemented architectures, functions and operations of the system, the method and the computer program product according to various embodiments of the present disclosure. In this regard, each block in the flowchart or block diagram may represent a module, a program segment, or a part of code, which contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by software or hardware. Among them, the name of the module does not constitute a limitation on the unit itself under certain circumstances.

The functions described above herein may be performed at least partially by one or more hardware logic components. For example, without limitation, exemplary types of hardware logic components that may be used comprise: a field programmable gate array (FPGA), an application specific integrated circuit (ASIC), an application specific standard product (ASSP), a system on chip (SOC), a complex programmable logical device (CPLD) and more.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus or device, or any suitable combination of the above. More specific examples of the machine-readable storage medium would comprise an electrical connection based on one or more lines, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, an example provides an TV series search method, comprising:
receiving picture content;
determining, based on picture information of the picture content, a target series matching the picture content and a target episode in the target series, the picture information comprising picture object information and/or picture scene information, and the target episode comprising an image frame matching the picture information of the picture content; and
displaying, on a preset interface, key information of the target episode, the key information representing at least the picture content.

According to one or more embodiments of the present disclosure, an example is the method, where the displaying, on the preset interface, key information of the target episode comprises at least one selected from a group of:
in response to the target series comprising one target episode, displaying, on the preset interface, the key information of the target episode; or
in response to the target series comprising a plurality of target episodes, displaying, on the preset interface, the key information of at least a part of the plurality of target episodes.

According to one or more embodiments of the present disclosure, an example is the method, where the step of displaying, on the preset interface, key information of at least some of the plurality of target episodes comprises one selected from a group of:
determining a first target episode from the plurality of target episodes based on authorized historical behavior information of a current account, and displaying, on the preset interface, key information of the first target episode;
determining a second target episode from the plurality of target episodes based on historical interaction information and/or plot information of the plurality of target episodes, and displaying, on the preset interface, key information of the second target episode; or
displaying, on the preset interface, the key information of each of the plurality of target episodes and the plot prompt information of each of the plurality of target episodes, the plot prompt information for prompting a plot corresponding to the picture content in the target episode.

According to one or more embodiments of the present disclosure, an example is the method, where the determining, based on picture information of the picture content, a target series matching the picture content and a target episode in the target series comprises:
determining, based on picture object information of the picture content, the target series matching the picture content; and
determining, based on the picture object information and picture scene information of the picture content, the target episode in the target series.

According to one or more embodiments of the present disclosure, an example is the method, where the method further comprises:
obtaining, based on the picture content and the target series matching the picture content, episode recommendation information in a plurality of dimensions, the plurality of dimensions comprising at least one selected from a group of an episode plot dimension, an episode object dimension, and an episode background dimension;
determining, based on the episode recommendation information in the plurality of dimensions, recommended episodes in the plurality of dimensions, respectively; and
displaying, on a preset interface, episode information of the recommended episodes.

According to one or more embodiments of the present disclosure, an example is the method, where the displaying, on the preset interface, episode information of the recommended episodes comprises:
displaying, on the preset interface, the episode information of the recommended episodes in different dimensions, wherein the episode information of the recommended episodes in different dimensions is displayed in different areas of the preset interface; or
displaying, on the preset interface, the episode information and dimension information of the recommended episodes.

According to one or more embodiments of the present disclosure, an example is the method, where after the displaying, on a preset interface, key information of the target episode, the method further comprises:
playing the target series in response to a series playback operation acting on the key information; and
adjusting a playback progress of the target series based on the image frame, in response to a progress adjustment operation for the target series.

According to one or more embodiments of the present disclosure, an example is the method, where the adjusting a playback progress of the target series based on the image frame, in response to a progress adjustment operation for the target series, comprises:
determining, in response to the progress adjustment operation for the target series, a target image frame corresponding to the progress adjustment operation in the target series, and adjusting a current playback progress of the target series to a target playback progress corresponding to the target image frame.

According to one or more embodiments of the present disclosure, an example is the method, where the method further comprises at least one selected from a group of:
displaying, in response to the playing of the target series, a progress adjustment control corresponding to the image frame, wherein the progress adjustment control is configured to trigger execution of the progress adjustment operation; or
displaying, in response to the playing of the target episode in the target series, image frame information of the image frame in the currently played target episode, wherein the image frame information is configured to trigger execution of the progress adjustment operation.

According to one or more embodiments of the present disclosure, an example is the method, where the receiving picture content comprises at least one selected from a group of:
receiving, in response to a first series search operation acting on a media content display interface, picture content currently displayed in the media content display interface; or
receiving, in response to a second series search operation acting on a series search interface, picture content in an image acquisition interface.

According to one or more embodiments of the present disclosure, an example provides a TV series search apparatus, comprising:
a picture receiving module, configured to receive picture content;
an episode determination module, configured to determine, based on picture information of the picture content, a target series matching the picture content and a target episode in the target series, the picture information comprising at least one selected from a group of picture object information or picture scene information, and the target episode comprising an image frame matching the picture information of the picture content; and
a key information display module, configured to display, on a preset interface, key information of the target episode, the key information representing at least the picture content.

According to one or more embodiments of the present disclosure, an example provides an electronic device, comprising:
one or more processors; and
a memory, configured to store one or more programs,
where the one or more programs, when executed by the one or more processors, cause the one or more processors to implement the TV series search method according to the above described examples.

According to one or more embodiments of the present disclosure, an example provides a computer-readable storage medium, on which a computer program is stored, where the computer program, when executed by at least a processor, implements the TV series search method according to the above described examples.

According to one or more embodiments of the present disclosure, an example provides a computer program product, which, when executed by a computer, causes the computer to implement the TV series search method according to the above described examples.

The above description is only a preferred embodiment of the present disclosure and an explanation of the technical principles employed. Those skilled in the art should understand that the disclosed scope involved in the present disclosure is not limited to the technical solutions formed by the specific combination of the above technical features, and should also cover, without departing from the above disclosed concept, other technical solutions formed by any combination of the above technical features or their equivalent features. For example, a technical solution formed by replacing the above features with technical features with similar functions disclosed in the present disclosure (but not limited to).

Additionally, although operations are depicted in a particular order, it should not be understood that these operations are required to be performed in the particular order shown or in a sequential order. Under certain circumstances, multitasking and parallel processing may be advantageous. Likewise, although the above discussion contains a number of specific implementation details, these should not be construed as limitations on the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. Conversely, the specific features and actions described above are merely example forms for implementing the claims.

1. A method for searching TV series comprising:
receiving picture content;
determining, based on picture information of the picture content, a target series matching the picture content and a target episode in the target series, the picture information comprising at least one selected from a group of picture object information or picture scene information, and the target episode comprising an image frame matching the picture information of the picture content; and
displaying, on a preset interface, key information of the target episode, the key information representing at least the picture content.

2. The method of claim 1, wherein the displaying, on the preset interface, key information of the target episode comprises at least one selected from a group of:
in response to the target series comprising one target episode, displaying, on the preset interface, the key information of the target episode; or
in response to the target series comprising a plurality of target episodes, displaying, on the preset interface, the key information of at least a part of the plurality of target episodes.

3. The method of claim 2, wherein the displaying, on the preset interface, key information of at least a part of the plurality of target episodes comprises one selected from a group of:
determining a first target episode from the plurality of target episodes based on authorized historical behavior information of a current account, and displaying, on the preset interface, key information of the first target episode;
determining a second target episode from the plurality of target episodes based on at least one selected from a group of historical interaction information or plot information of the plurality of target episodes, and displaying, on the preset interface, key information of the second target episode; or
displaying, on the preset interface, the key information of each of the plurality of target episodes and the plot prompt information of each of the plurality of target episodes, the plot prompt information for prompting a plot corresponding to the picture content in the target episode.

4. The method of claim 1, wherein the determining, based on picture information of the picture content, a target series matching the picture content and a target episode in the target series comprises:
determining, based on picture object information of the picture content, the target series matching the picture content; and
determining, based on the picture object information and picture scene information of the picture content, the target episode in the target series.

5. The method of claim 1, further comprising:
obtaining, based on the picture content and the target series matching the picture content, episode recommendation information in a plurality of dimensions, the plurality of dimensions comprising at least one selected from a group of an episode plot dimension, an episode object dimension, and an episode background dimension;
determining, based on the episode recommendation information in the plurality of dimensions, recommended episodes in the plurality of dimensions, respectively; and
displaying, on a preset interface, episode information of the recommended episodes.

6. The method of claim 5, wherein the displaying, on a preset interface, episode information of the recommended episodes comprises:
displaying, on the preset interface, the episode information of the recommended episodes in different dimensions, wherein the episode information of the recommended episodes in different dimensions is displayed in different areas of the preset interface; or
displaying, on the preset interface, the episode information and dimension information of the recommended episodes.

7. The method of claim 1, wherein after the displaying, on a preset interface, key information of the target episode, the method further comprises:
playing the target series in response to a series playback operation acting on the key information; and
adjusting a playback progress of the target series based on the image frame, in response to a progress adjustment operation for the target series.

8. The method of claim 7, wherein the adjusting a playback progress of the target series based on the image frame, in response to a progress adjustment operation for the target series, comprises:
determining, in response to the progress adjustment operation for the target series, a target image frame corresponding to the progress adjustment operation in the target series, and adjusting a current playback progress of the target series to a target playback progress corresponding to the target image frame.

9. The method of claim 8, wherein the method further comprises at least one selected from a group of:
displaying, in response to the playing of the target series, a progress adjustment control corresponding to the image frame, wherein the progress adjustment control is configured to trigger execution of the progress adjustment operation; or
displaying, in response to the playing of the target episode in the target series, image frame information of the image frame in a currently played target episode, wherein the image frame information is configured to trigger execution of the progress adjustment operation.

10. The method of claim 1, wherein the receiving picture content comprises at least one selected from a group of:
receiving, in response to a first series search operation acting on a media content display interface, picture content currently displayed in the media content display interface; or
receiving, in response to a second series search operation acting on a series search interface, picture content in an image acquisition interface.

11. An electronic device, comprising:
at least one processor; and
a memory communicatively connected to the at least one processor,
wherein the memory is stored with a computer program executable by the at least one processor, and the computer program, when executed by the at least one processor, causes the at least one processor to perform a method for searching TV series, which comprises:
receiving picture content;
determining, based on picture information of the picture content, a target series matching the picture content and a target episode in the target series, the picture information comprising at least one selected from a group of picture object information or picture scene information, and the target episode comprising an image frame matching the picture information of the picture content; and
displaying, on a preset interface, key information of the target episode, the key information representing at least the picture content.

12. The electronic device of claim 11, wherein the displaying, on the preset interface, key information of the target episode comprises at least one selected from a group of:
in response to the target series comprising one target episode, displaying, on the preset interface, the key information of the target episode; or
in response to the target series comprising a plurality of target episodes, displaying, on the preset interface, the key information of at least a part of the plurality of target episodes.

13. The electronic device of claim 12, wherein the displaying, on the preset interface, key information of at least a part of the plurality of target episodes comprises one selected from a group of:
determining a first target episode from the plurality of target episodes based on authorized historical behavior information of a current account, and displaying, on the preset interface, key information of the first target episode;
determining a second target episode from the plurality of target episodes based on at least one selected from a group of historical interaction information or plot information of the plurality of target episodes, and displaying, on the preset interface, key information of the second target episode; or
displaying, on the preset interface, the key information of each of the plurality of target episodes and the plot prompt information of each of the plurality of target episodes, the plot prompt information for prompting a plot corresponding to the picture content in the target episode.

14. The electronic device of claim 11, wherein the determining, based on picture information of the picture content, a target series matching the picture content and a target episode in the target series comprises:
determining, based on picture object information of the picture content, the target series matching the picture content; and
determining, based on the picture object information and picture scene information of the picture content, the target episode in the target series.

15. The electronic device of claim 11, the at least one processor is caused to further perform:
obtaining, based on the picture content and the target series matching the picture content, episode recommendation information in a plurality of dimensions, the plurality of dimensions comprising at least one selected from a group of an episode plot dimension, an episode object dimension, and an episode background dimension;
determining, based on the episode recommendation information in the plurality of dimensions, recommended episodes in the plurality of dimensions, respectively; and
displaying, on a preset interface, episode information of the recommended episodes.

16. The electronic device of claim 15, wherein the displaying, on a preset interface, episode information of the recommended episodes comprises:
displaying, on the preset interface, the episode information of the recommended episodes in different dimensions, wherein the episode information of the recommended episodes in different dimensions is displayed in different areas of the preset interface; or
displaying, on the preset interface, the episode information and dimension information of the recommended episodes.

17. The electronic device of claim 11, wherein after the displaying, on a preset interface, key information of the target episode, the method further comprises:
playing the target series in response to a series playback operation acting on the key information; and
adjusting a playback progress of the target series based on the image frame, in response to a progress adjustment operation for the target series.

18. The electronic device electronic device of claim 17, wherein the adjusting a playback progress of the target series based on the image frame, in response to a progress adjustment operation for the target series, comprises:
determining, in response to the progress adjustment operation for the target series, a target image frame corresponding to the progress adjustment operation in the target series, and adjusting a current playback progress of the target series to a target playback progress corresponding to the target image frame.

19. The electronic device of claim 18, wherein the at least one processor is caused to further perform at least one selected from a group of:
displaying, in response to the playing of the target series, a progress adjustment control corresponding to the image frame, wherein the progress adjustment control is configured to trigger execution of the progress adjustment operation; or
displaying, in response to the playing of the target episode in the target series, image frame information of the image frame in a currently played target episode, wherein the image frame information is configured to trigger execution of the progress adjustment operation.

20. A non-transitory computer-readable storage medium, wherein the computer-readable storage medium is stored with computer instructions, and the computer instructions, when executed by at least a processor, cause the processor to implement a method for searching TV series, which comprises:
receiving picture content;
determining, based on picture information of the picture content, a target series matching the picture content and a target episode in the target series, the picture information comprising at least one selected from a group of picture object information or picture scene information, and the target episode comprising an image frame matching the picture information of the picture content; and
displaying, on a preset interface, key information of the target episode, the key information representing at least the picture content.
